(19) United States
(12) Patent Application Publication
(10) Pub. No.: US 2007/0278324 A1
(43) Pub. Date: Dec. 6, 2007

(54) Device for cold gas spraying

(76) Inventors: Frank Gartner, Hamburg (DE); Peter Heinrich, Germering (DE); Heinrich Kreye, Hamburg (DE); Peter Richter, Heldenstein (DE); Tobias Schmidt, Eslohe (DE)

Correspondence Address: THE BOC GROUP, INC., 575 MOUNTAIN AVENUE, MURRAY HILL, NJ, 07974-2064, US

(21) Appl. No.: 11/801,456

(22) Filed: May 10, 2007

(30) Foreign Application Priority Data
May 18, 2006 (DE) 102006023483.9
Jul. 27, 2006 (EP) 06015705.4

(51) Int. Cl. B05B 1/24

(52) U.S. Cl. 239/132; 239/591

(57) ABSTRACT

The invention relates to a nozzle for cold gas spraying in which gas and spraying particles are accelerated. According to the invention, the cold gas spraying nozzle is at least partially coated at its inner wall.

### CROSS REFERENCE TO RELATED APPLICATIONS

This application claims priority from German Patent Application No. 102006023483.9 filed May 18, 2006 and European Patent Application No. 06015705.4 filed Jul. 27, 2006.

### BACKGROUND OF THE INVENTION

The invention relates to a cold gas spraying nozzle for accelerating gas and spraying particles, with the nozzle crossing over from a convergent section in the nozzle throat into a divergent section in flow direction. Furthermore, the invention relates to a cold gas spraying pistol comprising a cold gas spraying nozzle.

It is known to apply coatings onto materials of the most different types by means of thermal spraying. Known methods for doing so are flame spraying, arc spraying, plasma spraying or high-speed flame spraying, for example. More recently, a method, the so-called cold gas spraying, was developed, in which the spraying particles are accelerated to high speeds in a “cold” gas jet. The coating is formed by the incidence of the particles on the workpiece with high kinetic energy. In the event of impact, the particles, which do not melt in the “cold” gas jet, form a dense and firmly adhering layer, with plastic deformation and resulting local heat release ensuring cohesion and adhesion of the spraying layer on the workpiece. A heating of the gas jet heats the particles for an improved plastic deformation in the event of impact and increases the flow speed of the gas and thus also the particle speed. The gas temperature connected therewith is up to 800° C. (and above), but clearly lies below the melting temperature of the coating material so that a melting of the particles in the gas jet does not occur. An oxidation and/or phase conversions of the coating material can thus be avoided to a large extent. The spraying particles are added as powder, with the powder generally at least partially comprising particles with a size of from 1 to 50 μm. Such a method and a device for cold gas spraying are described in detail in European Patent EP 0 484 533 B1. A Laval nozzle is thereby used as a nozzle. Said nozzle will hereinafter in short be referred to as Laval nozzle. Laval nozzles are axially symmetrical and consist of a convergent and a divergent section, which follows thereon in flow direction. In the divergent region, the contour of the nozzle must be formed in a certain manner so as to avoid flow separation and so that densification impacts do not occur and the gas flow observes the laws according to Laval. Laval nozzles are characterized by this contour and by the length of the divergent section and furthermore by the ratio of the outlet cross-section to the narrowest cross-section. The narrowest cross-section of the Laval nozzle is called the throat nozzle. Presently common devices for cold gas spraying are designed for pressures of approximately 1 MPa up to a maximum pressure of 3.5 MPa and gas temperatures of up to approximately 800° C. The heated gas is relaxed together with the spraying particles in a Laval nozzle. While the pressure in the Laval nozzle decreases, the gas speed increases to values of up to 3000 m/s and the particle speed increases to values of up to 2000 m/s. Nitrogen, helium, argon, air or mixtures thereof are used. For the most part, however, nitrogen is used; higher particle speeds are achieved by means of helium or helium-nitrogen mixtures.

In practice, however, it is not possible to heat the gas and the particles to the desired temperature, which is maximally possible for the cold gas spraying, because the particles adhere to the inner wall of the nozzle in the event of temperatures, which are too high. Due to the adhesion of the particles to the inner wall of the nozzles, the nozzle clogs within a short time and can then no longer be used. The adhesion also changes the contour and thus the characteristics of the nozzle. The tendency to adhere to the inner wall of the nozzle is particularly pronounced for smaller particles of the spraying powder. However, a certain size distribution within the spraying particle powder cannot be avoided during the production. Furthermore, the increasing demands on the size selection considerably increase the price of the spraying powder.

The speeds of the gas and spraying particles when escaping the Laval nozzle, however, are first and foremost determined by the geometric dimensioning of the Laval nozzle. It follows from the characteristic parameters of the Laval nozzle that the inner diameter at the nozzle throat must be as small as possible because both of the parameters outlet cross-section and length of the divergent section are determined by the requirements to the outer measurements. Presently, nozzles are made, which comprise a diameter at the nozzle throat of between 2 and 3 mm. Due to the fact that the contours for the Laval nozzle must be created at the inner body and is, consequently, a bore, the production is extremely problematic because of the required dimensions. The production occurs, for example, by means of sink erosion in a cylinder or by means of a precision casting method, where the contour of the nozzle is produced by means of a model. To be able to produce nozzles comprising a complex contour having an arbitrary expansion ratio and sufficient length, it is known to make nozzles from two half shells. The nozzle contour is thereby inserted into the respective half shell by means of milling with high precision and the two completely processed half shells are put together to form one nozzle. Typically, steel is used as a nozzle material because steel is a material, which is easy to process. In some cases, hard metal tungsten carbide cobalt, which has certain advantages, is used as a nozzle material because the tendency of the particles to adhere to the inner wall of the nozzle is much lower with nozzles made of tungsten carbide cobalt than with nozzles made of steel. Tungsten carbide cobalt, however, is a material which is difficult to process so that the production of a nozzle made of this hard metal is very difficult and expensive. For manufacturing reasons for tungsten carbide cobalt it is not possible to produce the diverging section of the Laval nozzle in the desired length with given nozzle throat diameters.

### BRIEF SUMMARY OF THE INVENTION

The invention is thus based on the object of specifying a cold gas spraying nozzle, where the adhesion of the particles to the inner wall of the nozzle is not important and which is easy to produce. Also, the nozzle which is specified is able to increase the temperatures to which the gas and spraying particles, respectively, can be heated, without the particles adhering to the nozzle wall due to the instant particle size composition of the powder.

### DETAILED DESCRIPTION OF THE INVENTION

This object is solved in that the nozzle is at least partially coated at its inner wall. Due to the coating of the nozzle at its inner wall, a cold gas spraying pistol is available, where the adhesion of the particles to the inner wall of the nozzle is effectively prevented. The coating thus occurs by means of a material, which encompasses only little tendency to react with the material of the spraying particles. Furthermore, the nozzle according to the invention is simple to make because the nozzle body is made of a material, which can be processed well, such as steel and the coating prevents the adhesion of the spraying particles. Consequently, the problem of easily adding the nozzle is solved by the nozzle according to the invention.

It is furthermore possible to produce the nozzle according to the invention with any desired contour as well as in all desired measurements and measurement ratios. In particular, the length of the divergent nozzle section can be produced at a virtually arbitrary size, even with a small nozzle throat. Due to the fact that the adhesion is effectively prevented by means of the nozzle according to the invention, higher temperatures for gas and spraying particles are possible, as compared to uncoated nozzles. This improves the characteristic of the spraying layer as well as the application rate. Furthermore, spraying tools, which until now could not have been used, can now also be used and the use of powder, which is coarser than usual, is possible. It is thus possible to not only spray particles with up to 50 μm, as was common until now, but to use particles with up to 100 μm, partially even with a particle size of up to 250 μm. Furthermore, it is advantageous that, if the nozzle shows signs of wear, the coating can simply be repaired or can be renewed after a repair of the nozzle body.

Advantageously, the coating includes a hard, erosion and wear-resistant material. Such a material does not at all or only slightly react with the spraying particles under the temperature in the nozzle (due to the gas and the spraying particle heating, the nozzle also heats up). No reaction occurs at a temperature, which is greater than 0.5 times the melting temperature of the spraying material in Kelvin. The fact that no reaction occurs can be seen, for example, from the phase diagrams compiled in the tables, which can be found, e.g., in “Binary alloy phase diagrams” by T. B. Massalski, H. Okamoto, ASM International, 1992 or the positive mixing enthalpies, the tables regarding thermochemical data, e.g., “Thermochemical data of pure substances” by I. Barin, G. Platzki, V C H, Weinheim, N.Y., 1995 (ISBN: 3527287450). In summary, it can be stated that the coating encompasses special advantages, if it is very hard, if it adheres well to the nozzle material and if it has a smooth surface. A smooth surface is achieved in that either the nozzle contour is polished prior to the application of the coating and is subsequently coated by means of a very even application or in that it is polished after the application of the coating.

Advantageously, the nozzle is coated at least in the region of the nozzle throat. Particularly the region around the nozzle throat is affected by the adhesion, because this region forms the bottleneck for the gas and spraying particles. The coating is now advantageously applied at least in this region around the nozzle throat. This effectively prevents adhesion.

In an advantageous embodiment of the invention, the nozzle is made of two half shells. The nozzle is created by putting together the two half shells comprising a corresponding contour. Advantageously, the two half shells are coated when disjoined and are combined so as to fit perfectly after the application of the coating. By dividing the nozzle into two half shells, the production of the nozzles and, particularly, the production of nozzles comprising a very long divergent section, is easy to accomplish.

Particularly advantageously, the coating includes a metal, in particular chromium or a metal compound or an oxide ceramic. Among the metal compounds, carbides, nitrides and borides, that is, compounds of metals comprising carbon, nitrogen or boron, such as, for example, TiB₂, TiC, TiN, TiCN, TiB₂, TiBN, TiAlN, CrN, CrCN, ZrC, ZrN or also MiSi₂ and WSi₂ and also the metal oxide compounds, such as, for example, boron nitride or boron carbide, are particularly suitable. The so-called diamond-like-carbon or DLC layers are also suitable. Among the oxide ceramics, in particular TiO₂, ZrO₂ or Al₂O₃ are suitable. Phosphide coatings, such as NiP, for example, are also possible. Such coatings are characterized in that they are very hard, erosion and wear-resistant.

Particularly advantageously, the coating is an electrolytic coating or a coating applied by means of deposition from the gas phase. An electrolytically applied coating is also called galvanic. The PVD method (Physical Vapour Deposition) and the CVD method (Chemical Vapour Deposition) can be used, for example, as coating methods from the gas phase. Furthermore, it is also possible to apply the coating by means of thermal spraying.

In an advantageous embodiment of the invention, the coating is composed of two or more layers. The adhesion of the coating on the base material can, in certain cases, be improved by a layer design of the coating. The lower layer thereby serves as an adhesion promoter. The characteristics of the coating can be influenced as well by means of the layer design.

Particularly advantageously, the nozzle encompasses a gas/air or water cooling and/or cooling fins. The heat created during operation of the cold gas spraying nozzle is immediately discharged by means of nozzle cooling, so that the temperatures for gas and spraying particles can be increased further without the occurrence of adhesions. The application of a nozzle cooling thus supports the advantages of the invention.

Advantageously, the nozzle encompasses a diameter of from 1 to 6 mm at the nozzle throat and an expansion ratio of from 3 to 15, which is defined by the ratio of surface at the nozzle outlet to the surface at the nozzle throat and furthermore encompasses a length, which encompasses 30 to 100 times the diameter at the nozzle throat. The advantages regarding the cold gas spraying method is particularly supported by a coating of cold gas spraying nozzles, which are dimensioned in such a manner.

Furthermore, the object is solved by means of a cold gas spraying pistol comprising a cold gas spraying nozzle according to one of claims 1 to 9.

Further details of the invention will be explained below in more detail by means of an exemplary embodiment. According to this exemplary embodiment, a cold gas spraying nozzle consisting of two half shells, is coated. The two half shells of the nozzle are made of a steel and the inner surface of the two halves are coated with chromium. Nickel can thereby be used as an adhesion promoter. The application of the chromium as a so-called hard chromium comprising a hardness according to Vickers of typically 800 HV and more takes place by means of electrolytic (galvanic) deposition. The thickness of the chromium layer can thereby be from 2 to 100 μm. In case of copper as the spraying material, such a steel nozzle coated with hard chromium shows a similarly small tendency to adhere as does a nozzle, which was made from a hard metal. With the use of a cold gas spraying nozzle according to the invention, the impact speed of a 20 μm copper particle can be further increased from 630 m/s to 700 m/s because the nozzle according to the invention can be made with a very long divergent section and the adhesion of the spraying particles is effectively avoided. The advantages do not only appear during the spraying of powder made of copper but also during the spraying with powders made of steel, aluminium or aluminium alloys, for example.

We claim:

1. A cold gas spraying nozzle for accelerating gas and spraying particles, with the nozzle crossing over from a convergent section in the nozzle throat into a divergent section in flow direction, characterized in that the nozzle is at least partially coated at its inner wall.

2. The cold gas spraying nozzle according to claim 1, characterized in that the coating contains a hard, erosion and wear-resistant material.

3. The cold gas spraying nozzle according to claim 1, characterized in that the nozzle is coated at least in the region of the nozzle throat.

4. The cold gas spraying nozzle according to claim 1, characterized in that the nozzle is made of two half shells.

5. The cold gas spraying nozzle according to claim 1, characterized in that the coating includes a metal, in particular chromium or a metal compound or an oxide ceramic.

6. The cold gas spraying nozzle according to claim 1, characterized in that the coating is an electrolytic coating or a coating applied by means of deposition from the gas phase.

7. The cold gas spraying nozzle according to claim 1, characterized in that the coating is made up of two or more layers.

8. The cold gas spraying nozzle according to claim 1, characterized in that the nozzle encompasses a gas/air or water cooling and/or cooling fins.

9. The cold gas spraying nozzle according to claim 1, characterized in that the nozzle encompasses a diameter of from 1 to 6 mm at the nozzle throat and an expansion ratio of from 3 to 15, which is defined by the ratio of surface at the nozzle outlet to the surface at the nozzle throat and furthermore encompasses a length, which encompasses 30 to 100 times the diameter at the nozzle throat.

10. A cold gas spraying pistol comprising a cold gas spraying nozzle according to claim 1.
